(19) United States
(12) Patent Application Publication
(10) Pub. No.: US 2007/0210935 A1
(43) Pub. Date: Sep. 13, 2007

(54) Electronic parking meter with vehicle detecting sensor

(75) Inventors: Vincent G. Yost, Harleysville, PA (US); David A. Saar, Titusville, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Intellipark, LLC, Bethesda, MD (US)

(21) Appl. No.: 11/373,008

(22) Filed: Mar. 10, 2006

(51) Int. Cl. G08G 1/14; G07B 15/00

(52) U.S. Cl. 340/932.2; 705/13

(57) ABSTRACT

An electronic parking meter and vehicle detecting sensor for providing the electronic parking meter with the ability to reliably detect the presence or absence of a vehicle in any existing corresponding parking space, without the need to enter payment into the parking meter by an individual.

### BACKGROUND OF THE INVENTION

1. Field of Invention

This invention relates generally to the field of parking meters and more particularly to electronic parking meters that can detect parked vehicles.

2. Description of Related Art

Parking meters permit vehicles to be parked on streets for an allowable time determined by the number and denominations of coins which are placed in the parking meter. A clock mechanism in the parking meter runs down the allowable time until it reaches zero, and an overtime parking indication appears.

It has been long recognized that if the parking meter were able to detect the presence or absence of the vehicle, either by mechanical means or wireless means, in the corresponding parking space, then among other things, the parking meter could be reset, thereby requiring the next patron to insert the appropriate amount of payment for his/her parking time. U.S. Pat. No. 3,015,208 (Armer); U.S. Pat. No. 3,018,615 (Minton et al.); U.S. Pat. No. 3,034,287 (Odom et al.); U.S. Pat. No. 3,054,251(Handley et al.); U.S. Pat. No. 3,064,416 (Armer); U.S. Pat. No. 3,535,870 (Mitchell); U.S. Pat. No. 3,999,372 (Welch); U.S. Pat. No. 4,043,117 (Maresca et al.); 4,183,205 (Kaiser); U.S. Pat. No. 4,823,928 (Speas); U.S. Pat. No. 4,825,425 (Turner); U.S. Pat. No. 4,908,617 (Fuller); U.S. Pat. No. 4,967,895 (Speas); U.S. Pat. No. 5,442,348 (Mushell); RE29,511 (Rubenstein).

Thus, the objective of any vehicle detection portion of the electronic parking meter is to, as reliably as possible and as inexpensively as possible, detect when there is and is not a vehicle in the corresponding parking space. In fact, experience has shown that unless vehicle detection is extremely reliable (99%+ in correctly identifying the presence/absence of a vehicle), the customer, i.e., cities and townships, will not invest in vehicle detecting parking meters. However, all of the above references suffer from one of many different problems and actually achieving this objective remains elusive. The reasons for not being able to implement such a working vehicle detector include: the uncertainty of the parking meter location and of the parking meter/space environment, vehicles that are parked too far back in the parking space, the smoothness of the surfaces of different vehicles, the “fast parker”, the inadvertent or intentional presence of a person in front of the meter and tampering with the meter including the vandalizing of the sensor itself. Furthermore, the vehicle-detecting parking meter must be able to provide a reliable vehicle-detection scheme that uses low power since the parking meter is a stand-alone device that does not have the luxury of using utility power.

In particular, the environment of the meter/space presents obstacles that must be recognized and compensated for, or distinguished, by the vehicle detector. For example, the road may be very steeply-crowned and an ultrasonic-based vehicle detector will receive reflections from the crowned road, and may erroneously conclude that a vehicle is in the corresponding parking space when there truly is no vehicle there. Another example, is that if trash bins, light posts, trees, sign posts, etc. are closely-adjacent the parking meter, almost any wireless vehicle detection scheme will be subjected to sufficient interferences from these, thereby causing the detector to make erroneous conclusions about the presence/absence of a vehicle in the parking space.

Even the sensor used to implement the vehicle detection suffers from its own respective drawbacks. For example, the use of RADAR (radio detection and ranging) suffers from such things as possible interferences from other RADAR-vehicle-detecting units, frequency band licensing concerns as well as cost. The use of optical sensors in vehicle detection (e.g., U.S. Pat. No. 4,043,117 (Maresca)) suffer from receiving reflections that may vary from strong reflections (reflected off of vehicle glass) versus weak reflections (reflected off the body of a very dark-colored vehicle), which are hard to detect. Video camera/processing when used for vehicle detection (e.g., U.S. Pat. No. 5,777,951 (Mitschele, et al.)) is not only very expensive but in those cases where the video camera is positioned to capture the front-end vehicle license plate, in those states where front-end vehicle license plates are not required, identification of the vehicle is thwarted. Thus, at present, use of ultrasonic sensors remains the most cost-effective means of detecting vehicles.

Prior art vehicle detecting parking meters utilizing a single ultrasonic sensor, such as those disclosed in U.S. Pat. No. 5,407,049 (Jacobs), U.S. Pat. No. 5,454,461 (Jacobs), U.S. Pat. No. 5,570,771 (Jacobs), U.S. Pat. No. 5,642,119 (Jacobs), U.S. Pat. No. 5,852,411 (Jacobs et al.), U.S. Pat. No. 6,195,015 (Jacobs, et al.), U.S. Pat. No. 6,078,272 (Jacobs, et al.) and U.S. Pat. No. 6,275,170 (Jacobs, et al.), operate where the ultrasonic sensor is energized with a pulse for emanating an interrogating signal towards the parking space and then the sensor waits to receive reflections. In particular, the reflections are examined to determine if they exceed a certain fixed threshold and, if so, the time measured between when the interrogating signal was sent until when the reflection was received is used to calculate a distance.

However, some of the problems with such a method are the following: certain vehicles disperse the interrogating signal, rather than returning a strong reflection; another problem is that to compensate for adjacent obstacles, e.g., crowned-street, tree, sign post, etc., the sensitivity of the sensor has to be reduced by raising the threshold but in doing so, even more vehicles are not properly detected; the reflected signals, or echos, are inherently unstable, i.e., the movement of air and even very minute physical movements in the environment make these signals unstable. Furthermore, some echos cancel other echos and exhibit multi-path problems, thus making the echos unstable.

Even where multiple ultrasonic sensors are used to detect vehicles, e.g., U.S. Pat. No. 3,042,303 (Kendall et al.); U.S. Pat. No. 3,046,519 (Polster); U.S. Pat. No. 3,046,520 (Polster); U.S. Pat. No. 3,105,953 (Polster); U.S. Pat. No. 5,263,006 (Hermesmeyer); U.S. Pat. No. 4,845,682 (Boozer et al.), or other objects U.S. Pat. No. 5,761,155 (Eccardt et al.), the design is that at least one sensor acts as an ultrasonic transmitter and the remaining sensors act as the ultrasonic receivers. As a result, there is no teaching or suggestion that each sensor act as both a transmitter/receiver for a signal that monitors a particular portion of the parking space. Furthermore, low power operation of these system is not a concern.

Another problem that is encountered with such vehicle detection systems is a “fast-parker” scenario, i.e., a vehicle pulling into a parking space that has just been emptied but before the vehicle detector has determined that the first vehicle has departed. One solution proposed to this problem is disclosed in U.S. Pat. No. 6,229,455 (Yost, et al.) and which is also incorporated by reference herein. In that patent, three vehicle detecting sensors are provided in a housing that is located between an electronic parking meter and the coin vault. These sensors are directed downward and each sensor is focused on a different portion of the parking space. A verification process is used by an internal processor to provide a reliable determination as to whether a vehicle is present or not in the corresponding parking space.

With regard to low power electronic parking meters, British Publication No. 2077475 discloses a low power electronic parking meter that operates using solar cells. Furthermore, since the sophisticated electronic parking meters which use microprocessors, electronic displays and IR/ultrasonic transducers consume too much power to operate by non-rechargeable batteries alone, U.S. Pat. No. 4,967,895 (Speas) discloses the use of solar power cells which charge capacitors or rechargeable batteries. However, various problems exist with the use of solar power sources including the use of parking meters in shady areas, or the use of parking meters during periods in which there is very little sunlight. This causes the rechargeable batteries to run down, and they require frequent replacement. Or, in the case of the use of capacitors, the lack of power causes the meter to become inoperative.

Therefore, there remains a need a system and method for providing any electronic parking meter with the ability to detect the presence or the absence of a vehicle in any existing parking meter space, independent of the surrounding environment, as reliably as possible and as inexpensively as possible while using a minimum of power.

All references cited herein are incorporated herein by reference in their entireties.

### BRIEF SUMMARY OF THE INVENTION

An electronic parking meter mounted on a support (e.g., stanchion) anchored to the ground and adjacent a corresponding parking space. The electronic parking meter comprises: a stand-alone (e.g., self-sufficient as to power) electronic parking meter housing comprising a display and supporting electronics; a vehicle detecting sensor (e.g., an ultrasonic transducer) located on the support for detecting the presence or absence of a vehicle in a corresponding parking space, and wherein the sensor transmits signals wirelessly towards the parking space and for receiving reflections of the signals if a vehicle is present; a processor coupled to the vehicle detecting sensor for processing the reflections of the signals, wherein the processor is in communication with the supporting electronics for communicating the presence or absence of a vehicle in the corresponding parking space to the electronic parking meter; and wherein the supporting electronics, processor and vehicle detecting sensor are continuously enabled.

A method for automatically leasing, and displaying violations of, the use of a parking space. The method comprises the steps of: positioning a stand-alone electronic parking meter (e.g., self-sufficient as to power) having a display and supporting electronics including coin or payment card processors on a support (e.g., a stanchion) anchored to the ground and adjacent the parking space; positioning a vehicle detecting sensor on the support at a predetermined height above the ground, and wherein the vehicle detecting sensor and the supporting electronics are in communication with each other; orienting the vehicle detecting sensor for emitting wireless signals towards the parking space at a predetermined angle with respect to a horizontal reference, and wherein the vehicle detecting sensor also receives any reflections of the emitted wireless signals; processing the received reflections to determine the presence or absence of a vehicle in the parking space and informing the supporting electronics of the presence or absence of a vehicle in the parking space; and continuously enabling the electronic parking meter and vehicle detecting sensor.

### BRIEF DESCRIPTION OF THE DRAWINGS

The following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a side view of the electronic parking meter and vehicle detecting sensor located in the stanchion and showing a vehicle parked in the corresponding parking space;

FIG. 2 is a partial parking-space side view of the electronic parking meter and vehicle detecting sensor shown mounted in the stanchion and angled upward;

FIG. 3 is a cross-sectional view of the intermediate housing taken along line 3-3 of FIG. 2 is showing the processor of the vehicle detecting sensor processing electronics;

FIG. 4 is a cross-sectional view of the stanchion depicting how the vehicle detecting sensor is positioned therein and taken along lines 4-4 of FIG. 2;

FIG. 5 is a block diagram of the present invention;

FIG. 6A-6B, together constitute a flow chart of the microcomputer of the vehicle detecting sensor processing electronics;

FIG. 7a is the reflected signal characteristic when no vehicle is detected in the corresponding parking space;

FIG. 7b is the reflected signal characteristic when the vehicle detecting sensor is being tampered with, such as placing a finger or hand over the sensor;

FIG. 8 is a partial parking-space side view of a double electronic parking meter configuration with respective vehicle-detecting sensors shown mounted accordingly in the stanchion, angled upward, and oriented to face corresponding adjacent parking spaces;

FIG. 9 is a cross-sectional view of the stanchion of FIG. 7 taken along line 8-8 showing the mounting of each vehicle detecting sensor;

FIG. 10 is a partial sidewalk side view of a double electronic parking meter configuration with respective vehicle-detecting sensors shown mounted accordingly in the stanchion, angled upward, and oriented to face corresponding adjacent parking spaces;

FIG. 11 is a figure layout for FIGS. 11A-11D;

FIG. 11A is an electrical schematic of a voltage regulator circuit of the vehicle detecting sensor processing electronics, a portion of the transducer interface circuit and an optional battery monitoring circuit;

FIG. 11B is an electrical schematic of the other portion of the amplifier input circuit and the transducer driver/listen circuit;

FIG. 11C is an electrical schematic of the microcontroller of the vehicle detecting sensor processing electronics; and

FIG. 11D is an electrical schematic of the memory of the vehicle sensor processing electronics.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

It should be understood that the invention of the present application is an improvement over that of U.S. Pat. No. 6,229,455 (Yost, et al.) and whose entire disclosure is incorporated by reference herein. In general, one of the key improvements of the present invention over the invention disclosed in U.S. Pat. No. 6,229,455 (Yost, et al.) is the use and placement of a single vehicle detecting sensor 421 rather than the use of three such sensors adjacent the parking meter housing. Furthermore, the present invention does not use an optical tamper system as also disclosed in U.S. Pat. No. 6,229,455 (Yost, et al.).

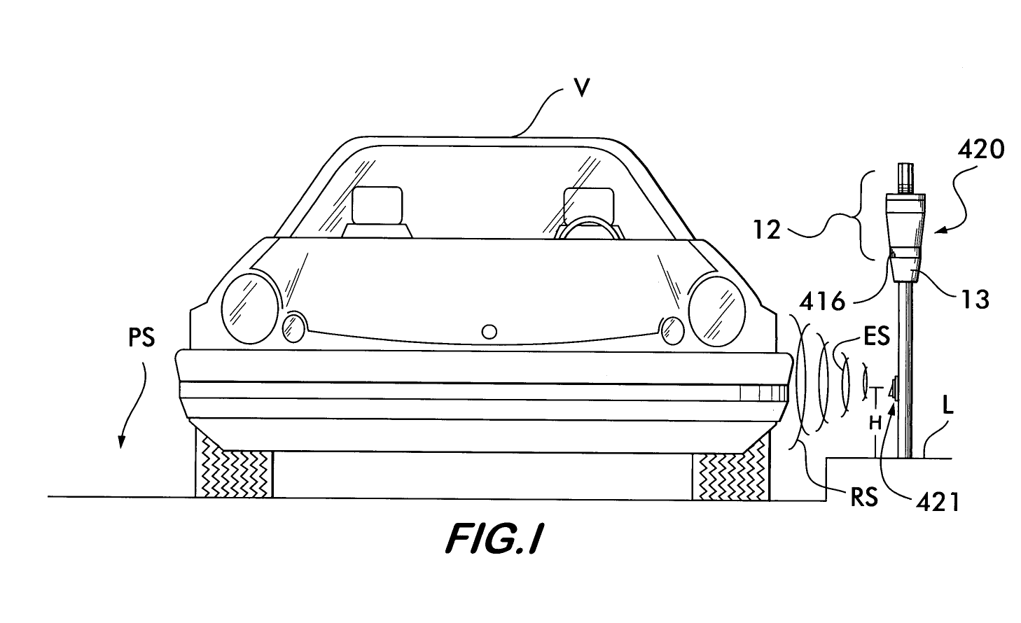

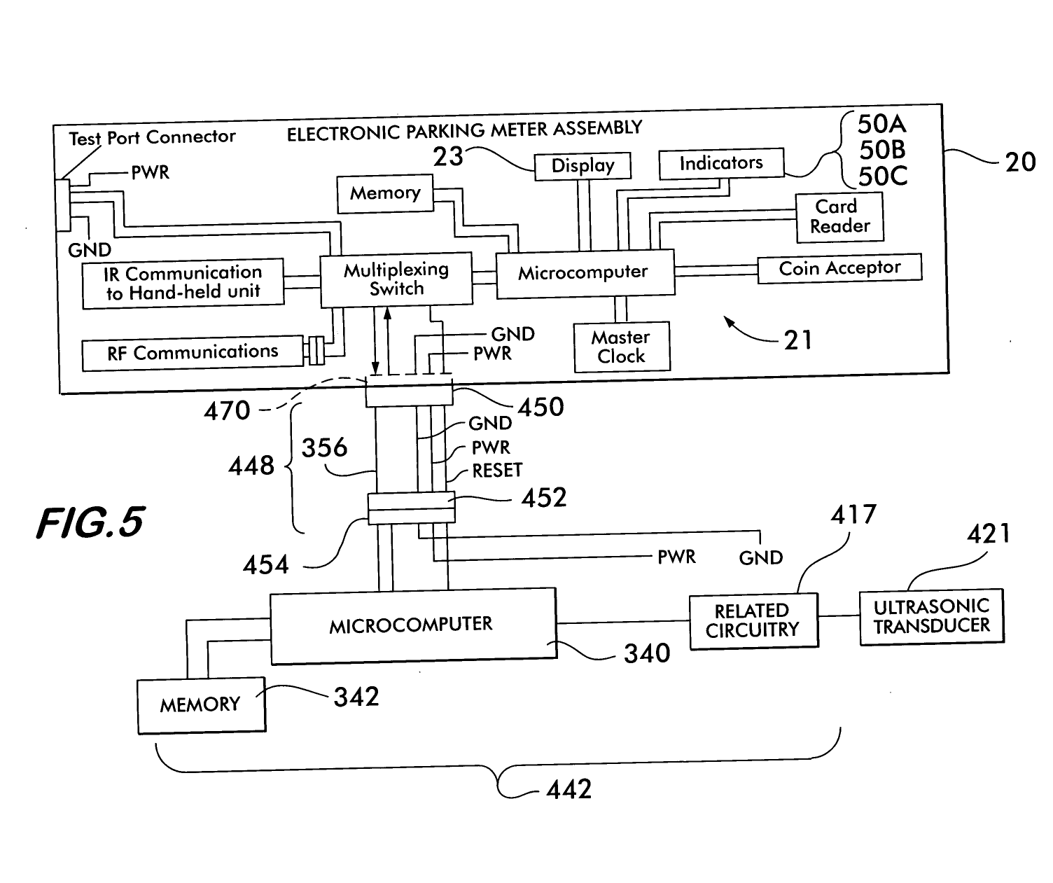

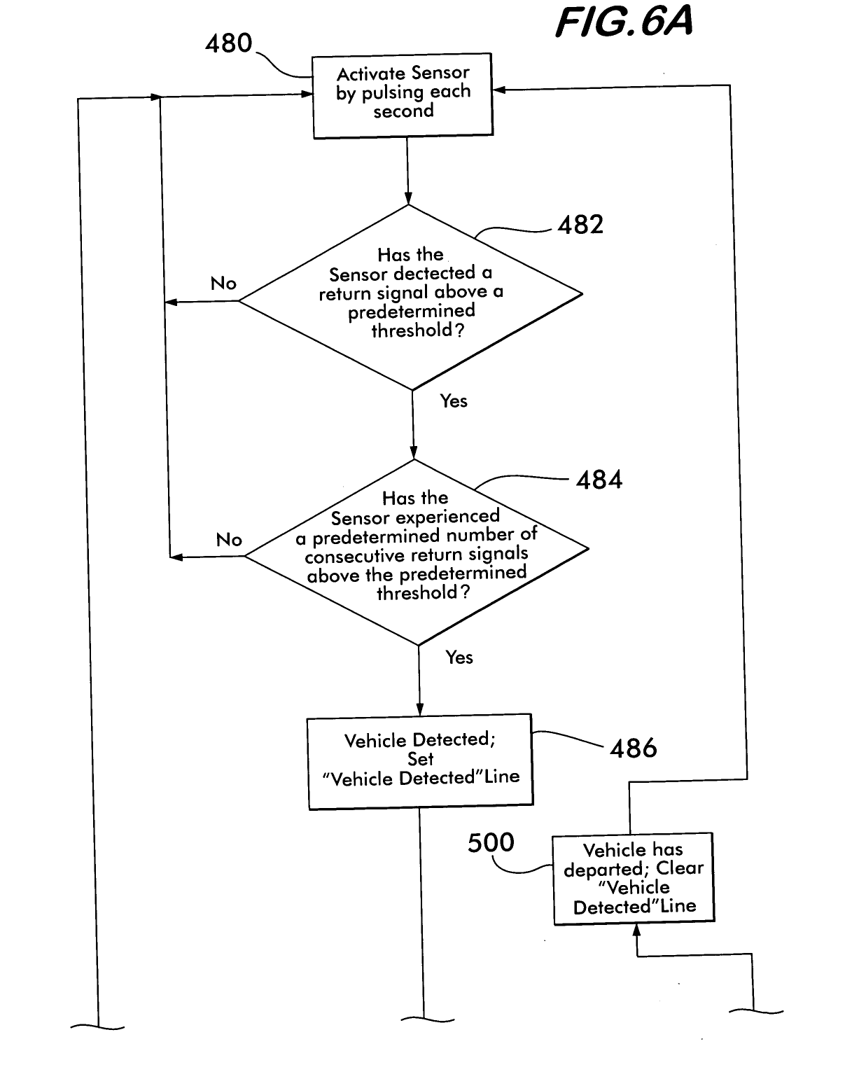

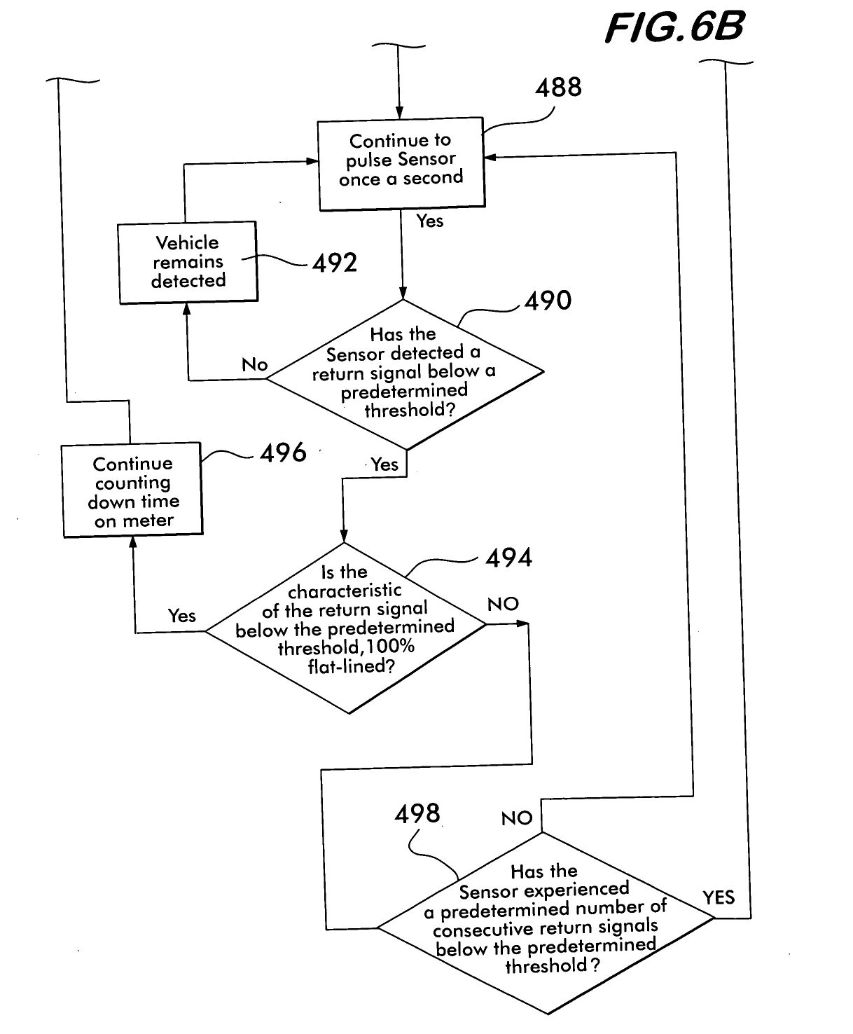

FIG. 1 depicts the invention 420 of the present invention installed adjacent a corresponding parking space PS that is occupied by a vehicle V. In particular, the present invention 420 comprises an electronic parking meter assembly 12 that is supported on a stanchion (or any other type of support anchored in the ground) 14. A vehicle detecting sensor 421 (e.g., an ultrasonic sensor) is mounted at in the stanchion 14 at a predetermined height H above a ground reference level L. The vehicle detecting sensor 421 is in electrical communication with the electronic parking meter assembly 12. The electronic parking meter assembly 12 may be coupled to a vault 13 (which receives the deposited coins) via an intermediate housing 416, or alternatively, the electronic parking meter assembly 12 may be directly coupled to the vault 13. In general, the vehicle detecting sensor 421 is pulsed at regular intervals (e.g., once a second) to form emitted signals ES; if reflected signals RS are returned to the sensor 421 this information is processed by vehicle detecting sensor processing electronics 422 (FIG. 5) and then passed to the electronic parking meter assembly 12.

Unlike known stand-alone parking meters that claim to detect vehicles, the present invention 420 is always enabled. In particular, the electronic parking meter assembly 20 and the vehicle detecting sensor 421 work together to check for vehicle presence or absence. Therefore, they do not require that coins or a payment card be inserted to activate the parking meter and its vehicle detecting capability. The continuously enabled feature is important because the parking meters of the present invention 420 are “stand-alone” types. As used throughout this Specification, the term “stand-alone” means that the EPMA 20/and vehicle detecting sensor 421 are not hard-wired to any utility power. For example, the EPMA 20/vehicle detecting sensor 421 may include on-board power such as batteries, fuel cells, solar cells, wind power, etc. In other words, the present invention 420 must be self-sufficient and therefore must operate to conserve or minimize power consumption while accurately detecting incoming or departing vehicles and displaying the appropriate purchased time or violation indicators.

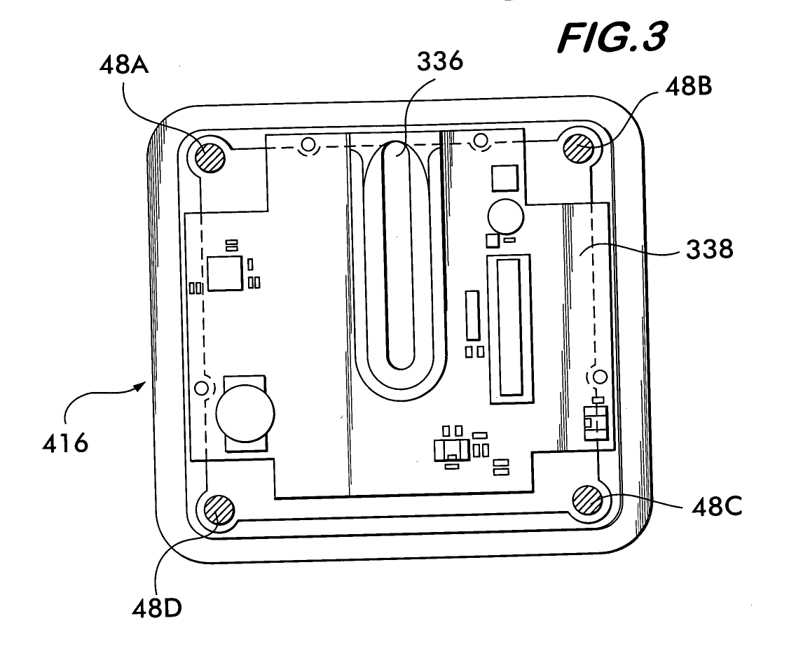

FIG. 5 provides a block diagram of the invention 420. The electronic parking meter assembly 20 contains supporting electronics 21, a display 23 and indicators 50A-50C. The vehicle detecting sensor 421 is electrically coupled to the electronic parking meter assembly 20 via vehicle detecting sensor processing electronics 422. These electronics 422 include a microcomputer 340, a memory 342 and related circuitry 417. It should be noted that where the intermediate housing 416 is used with electronic parking meter assembly 20, the vehicle detecting sensor processing electronics 422 can be housed within the intermediate housing 416, as shown in FIG. 3; alternatively, where the intermediate housing 416 is not used, the electronics 422 can be housed within the stanchion 14 or form a part of the supporting electronics in the electronic parking meter assembly 20. Thus, it should be understood that the scope of the invention is not limited in any way to the presence or absence of the intermediate housing 416.

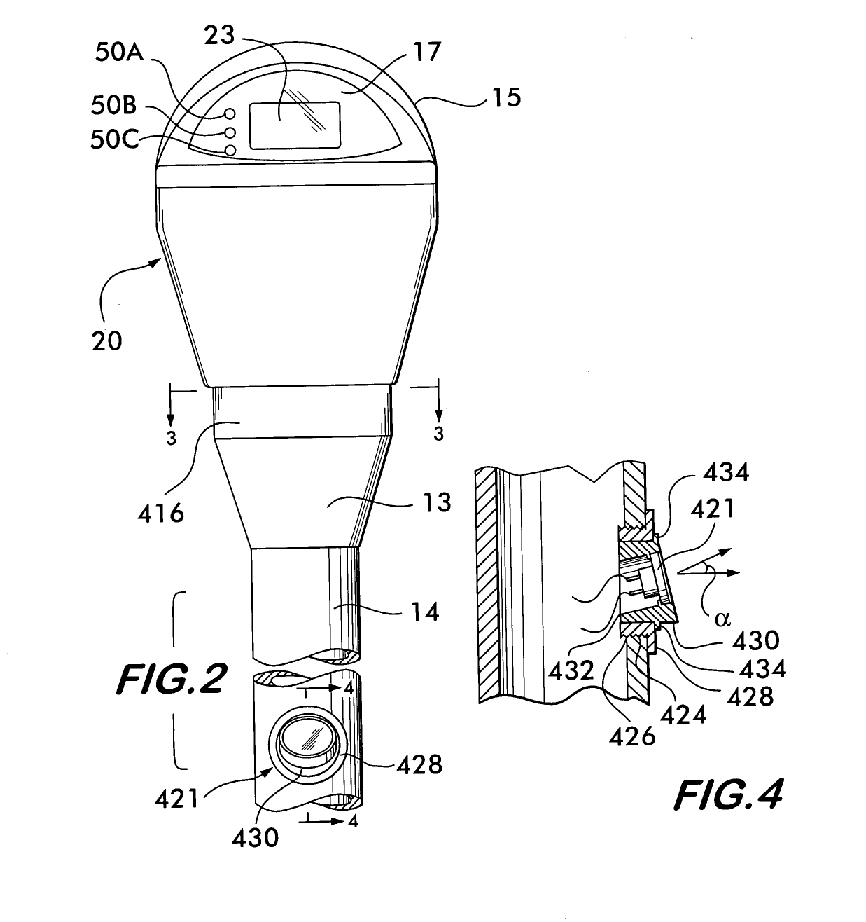

The operative part of the electronic parking meter assembly, hereinafter known as the EPMA 20 is positioned inside a housing 12; examples of such electronic parking meters, by way of example only, are those disclosed in U.S. Pat. No. 6,109,418 (Yost); U.S. Pat. No. 6,275,170 (Jacobs, et al.); U.S. Pat. No. 6,195,015 (Jacobs, et al.); or U.S. Pat. No. 5,642,119 (Jacobs); however, it should be understood that any electronic parking meter would suffice. By way of example only, the EPMA 20 (see FIG. 2) comprises a parking meter cover 15 having a lens portion 17 and which can only be removed by parking authority personnel to obtain access to the EPMA 20.

An electronic display (e.g., LCD, LED, etc.) 23 can be seen through the lens 17, as well as three LEDs 50A-50C mounted therein which can be used for indicating various parking meter conditions to parking authority personnel.

As shown in FIG. 2, which depicts the street-side of the EPMA 20, the vehicle detecting sensor 421 is oriented in an upward position. FIG. 4 shows most clearly the vehicle detection sensor being oriented at an upward angle α of approximately 25° to 35° and most preferably, 30°, with respect to a horizontal reference. This provides the most reliable aim at detecting different types of vehicles V parked in the corresponding parking space PS. One manner of producing this preferred angular orientation is by introducing a threaded insert 424 into a corresponding threaded aperture 426 in the stanchion 14. The insert 424 also comprises a flange 428 that abuts the outer surface of the stanchion 14 when tightened properly against the stanchion 14. The vehicle detecting sensor 421 (e.g., an ultrasonic transducer) is fixedly secured within a sleeve 430 which comprises an outer circular surface that corresponds to the insert 424 but has an inner channel 432 that is angled and into which the vehicle detecting sensor 421 is fixed secured. Thus, with the sensor 421 secured within the sleeve 430, the sleeve 430 is forced into the channel 432 in the insert 424 and rotated to achieve the appropriate angular orientation discussed previously. An adhesive (not shown) can be applied to the outer surface of the sleeve 430 before insertion to fixedly secure the sleeve 430 within the insert 424 so that the vehicle detecting sensor 421 is fixed at the appropriate angle α, most preferably 30°, as discussed previously. A lip 434 at the front of the sleeve 430 acts as a positive stop against the flange 428 to make certain that the sleeve 430 is inserted fully within the insert 424.

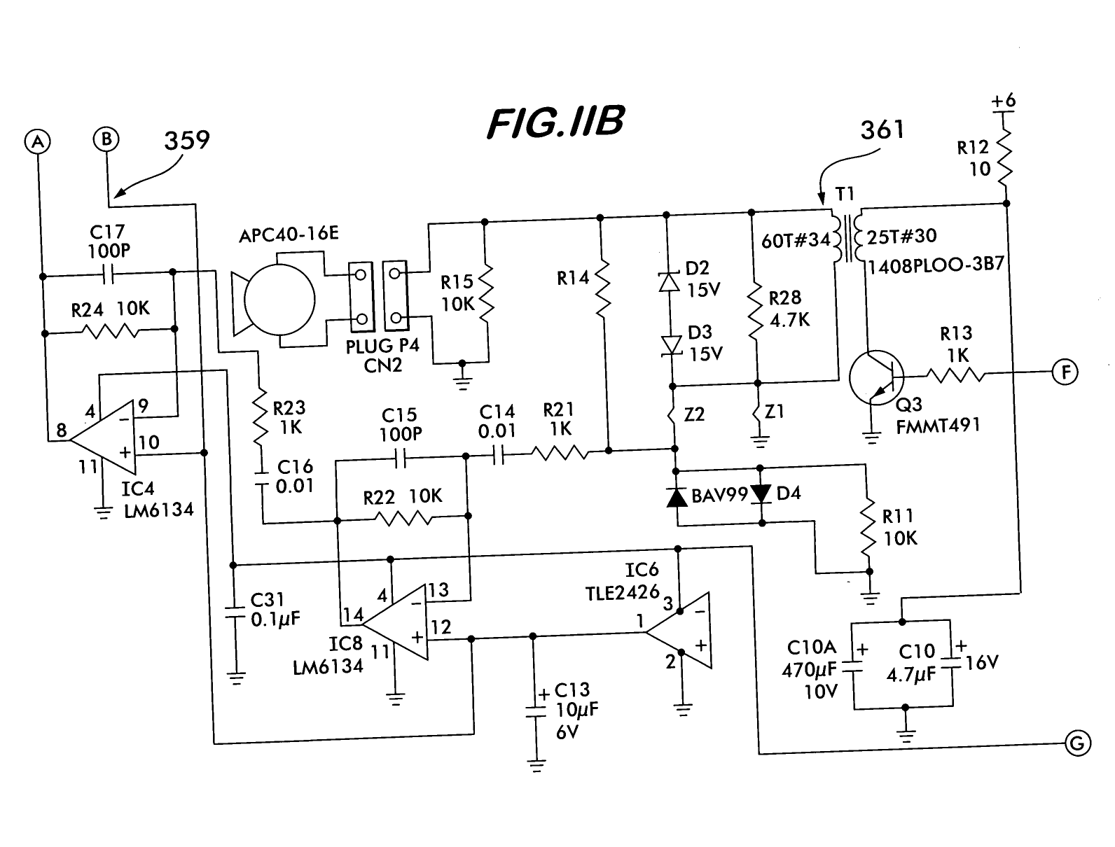

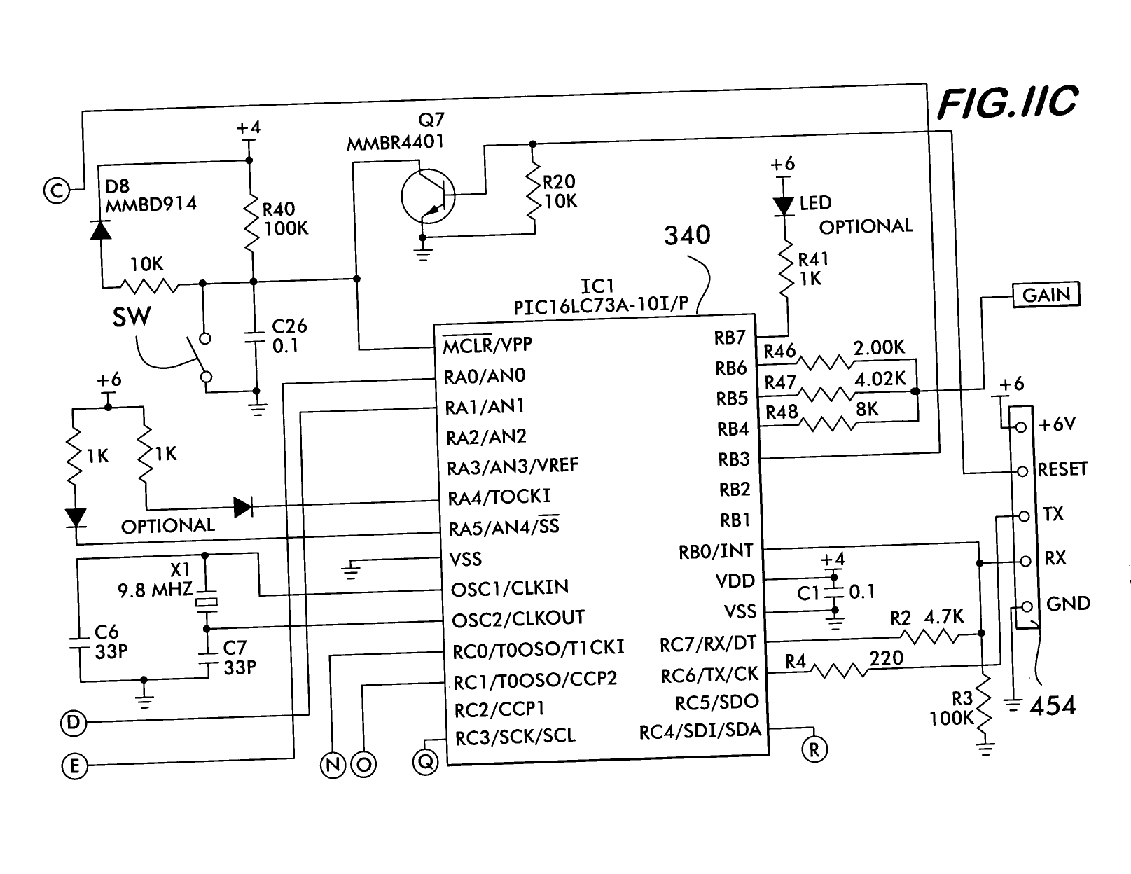

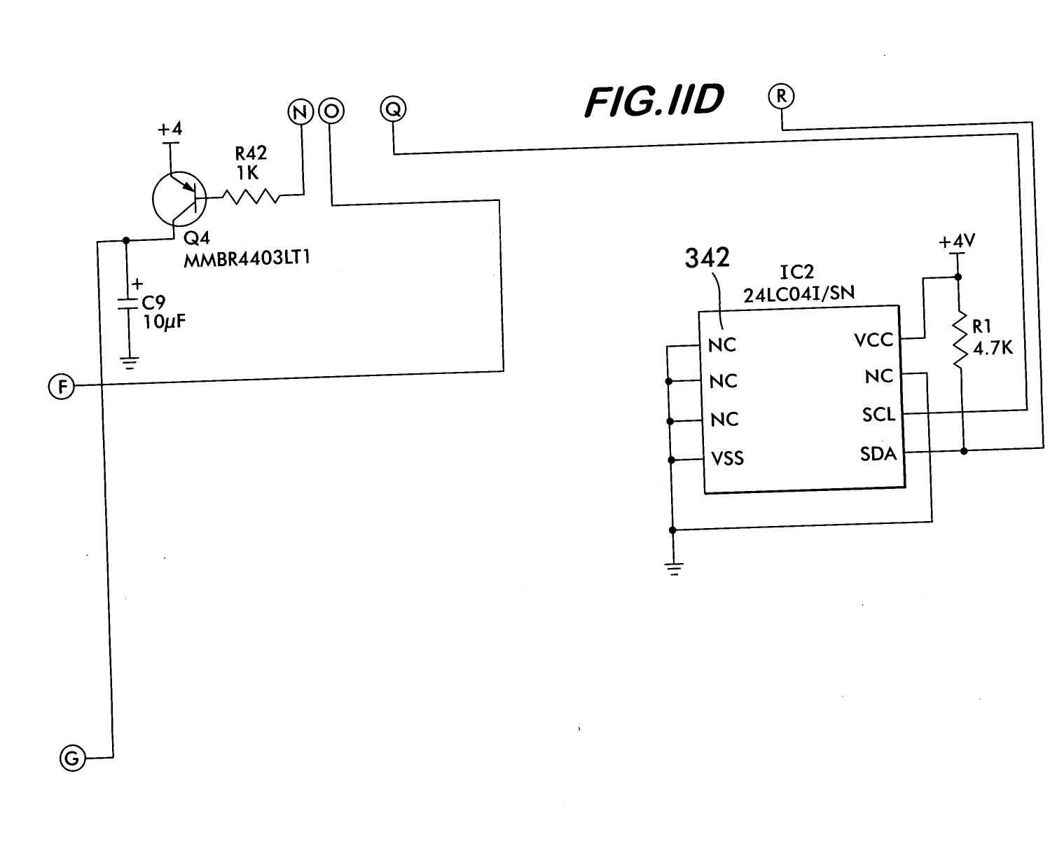

Similarly, the vehicle detecting sensor 421 is mounted at in the stanchion 14 at a predetermined height H (see FIG. 1), e.g., 15-25 inches, most preferably 21 inches, above a ground reference level L, as shown most clearly in FIG. 1.

Where the intermediate housing 416 is used, it is secured between the EPMA housing 12 and the vault 13 using a plurality of bolts 48A-48D (FIG. 3) that can only be accessed by parking meter personnel, such as disclosed in U.S. Pat. No. 5,852,411 (Jacobs et al.), and which is incorporated by reference herein. As can be also seen in FIG. 3, the intermediate housing 416 includes a coin passageway 336 for permitting the coins processed by the EPMA 20 to pass through the intermediate housing 416 and into the vault 13. A printed circuit board (PCB) 338, which contains vehicle detecting sensor processing electronics 422 (FIGS. 11A-11D) can also be seen in FIG. 3, as is discussed below.

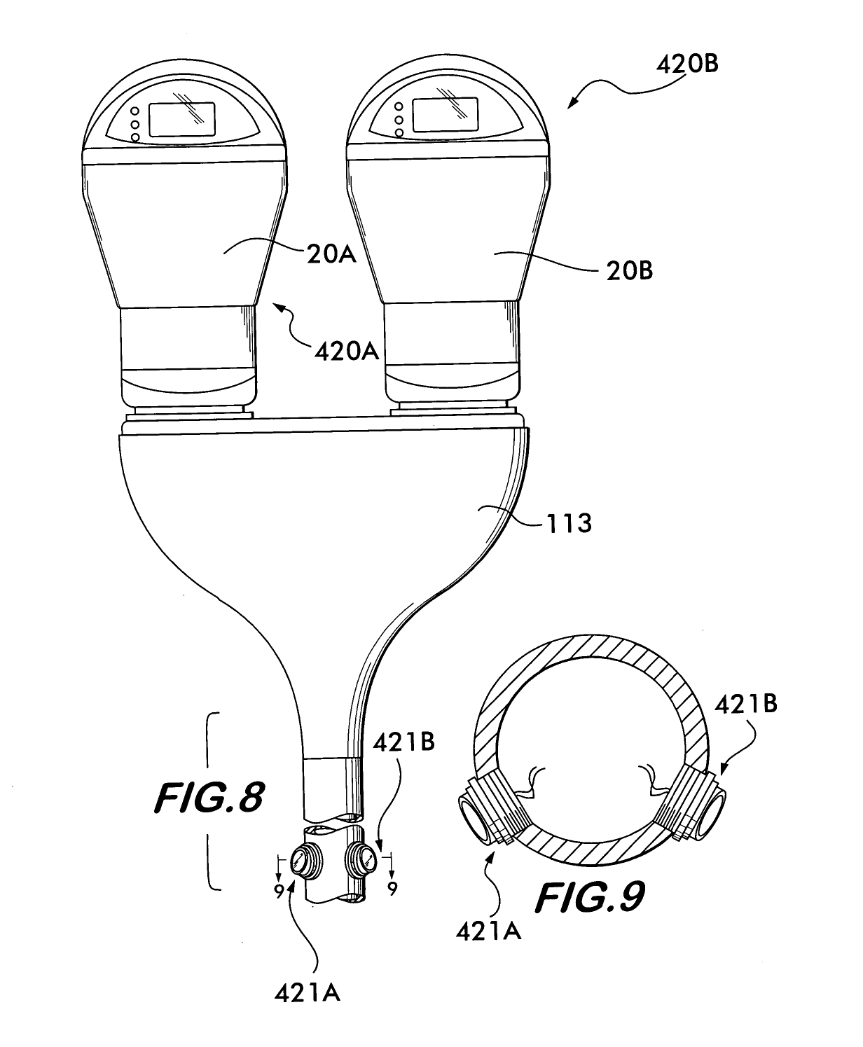

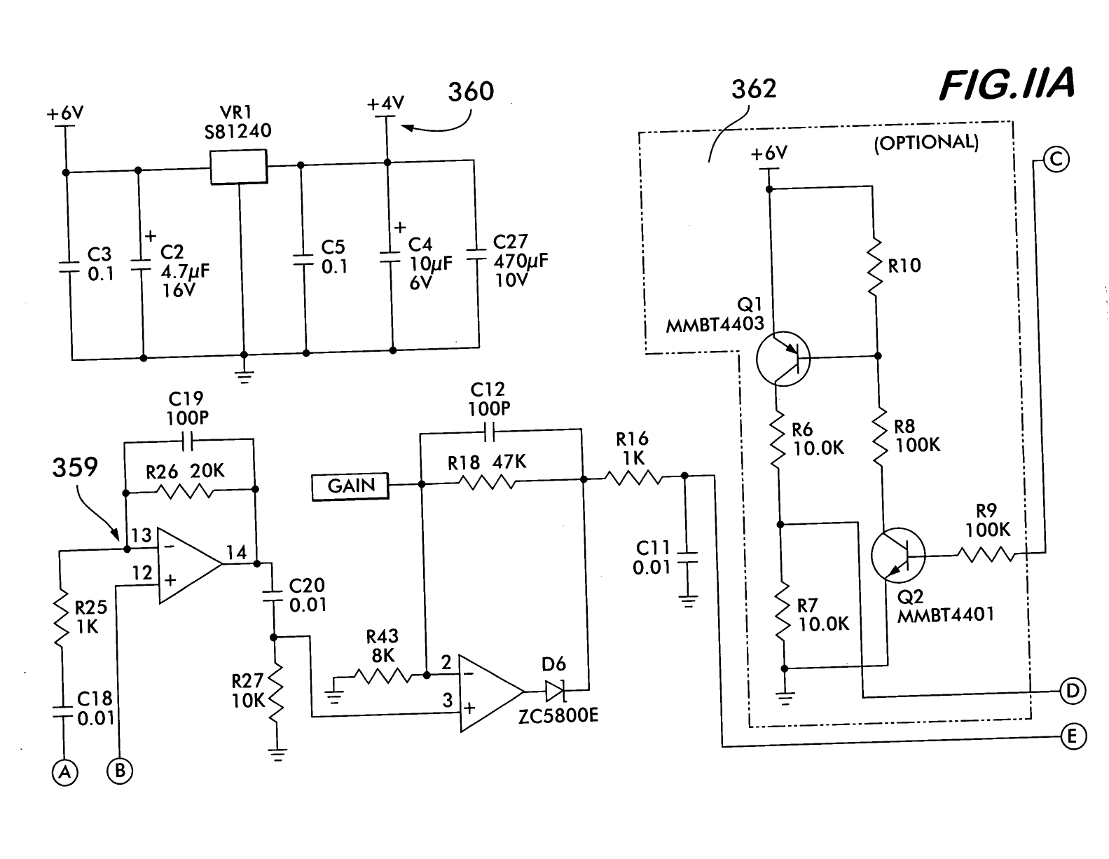

Furthermore, coins or payment cards (e.g., debit cards, credit cards, smart cards, etc.) can be inserted in respective apertures (see FIG. 10 depicting card insert slot 5 and coin insert slot 7) on the sidewalk side of the EPMA 20; this side of the EPMA 20 is depicted in FIGS. 8-10 which shows a double EPMA 20 configuration, as will be discussed later.

As mentioned earlier, the vehicle detecting sensor processing electronics 422 comprises microcomputer (μC) 340, memory 342, related circuitry 417 and the vehicle detecting sensor (e.g., ultrasonic transducer) 421 (FIG. 5). An electrical wire harness 448 comprises a first connector 450 and a second connector 452 that plug into respective mating connectors 470 (on the EPMA 20) and 454 in the vehicle detecting sensor processing electronics 422. The wire harness 448 provides power (PWR, +6VDC) and ground (GND) from the EPMA 20 as well as a reset line (RESET); the RESET line permits the both the EPMA 20 and the vehicle detecting sensor processing electronics 422 to be simultaneously reset by parking meter personnel whenever they are doing maintenance on the EPMA 20. Furthermore, a “vehicle detected” line 356 is also provided for passing a “vehicle-detected” status to the EPMA 20 to the EPMA 20, respectively, as will be discussed in detail later. It should be understood that the use of a wire harness between EPMA 20 and the vehicle detecting sensor processing electronics 422 is by way of example only and does not limit the scope of the invention to a wired interface. Alternatively, there could be a wireless interface between the EPMA 20 and the vehicle detecting sensor electronics 422 (e.g., “Bluetooth” or other wireless protocol). Another alternative, as mentioned previously, could have the vehicle detecting sensor electronics 422 formed as part of the electronics of the EPMA 20 and there could be wireless interface between the vehicle detecting senor 421 and the vehicle detecting sensor processing electronics 422. Thus, it is within the broadest scope of the present invention to include either a wired or a wireless interface between the electronics of the EPMA 20, the vehicle detecting sensor processing electronics 422 and the vehicle detecting sensor 421.

The memory 342 stores the operational parameters of the vehicle detecting sensor processing electronics 422. For example, the memory stores the baseline signals, (e.g., the transducer signal corresponding to an empty parking space), reference parameters, transducer frequency data, etc. In addition, the memory can be updated or modified through the EPMA 20 via using the “vehicle-detected” line 356. In particular, when the baseline signals are obtained for the sensor 421, parking meter personnel control that process via a hand-held unit (not shown) that communicates with the EPMA 20 and ultimately with the vehicle detecting sensor processing electronics 422.

The vehicle detecting sensor 421 (e.g., an ultrasonic transducer) operates at a nominal frequency, e.g., 40 kHz. To ensure that all possible situations of environmental changes do not affect the vehicle detection processing, the μC 340 excites the sensor 421 at a slightly higher and lower frequency around the nominal frequency. However, in the baseline case, to detect a vehicle at all, only the nominal frequency is monitored.

The μC 340 controls the activation of the sensor 421. It should be understood that the phrase “activating the sensor” as used in this patent application means: (1) energizing the transducer; (2) listening for the reflection; and (3) processing the reflection by the μC 340. By way of example, and not limitation, the energization phase is approximately 1 msec, the listening phase is approximately 14-16 msec and the processing phase is approximately 20 msec. Thus, “activating the sensor (or transducer)” is approximately a 40 msec process.

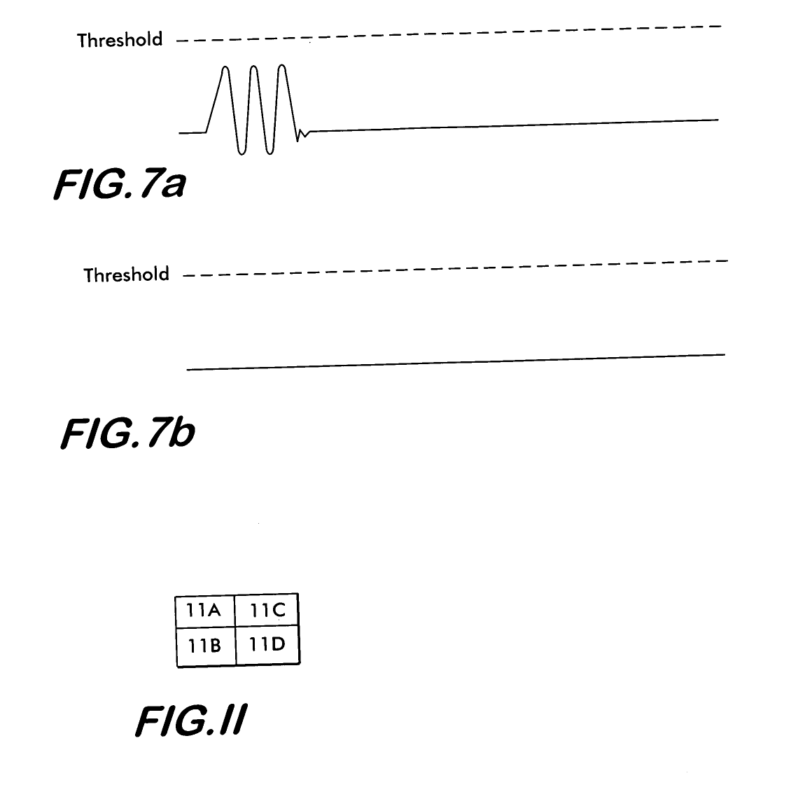

FIGS. 7a-7b depict the flowchart for the μC 340. In particular, in step 480 the μC 340 activates the sensor 421 by pulsing it each second. In step 482, the μC 340 determines whether the sensor 421 has detected a reflected signal RS above a predetermined threshold (e.g., the noise level). If not, the μC 340 returns to pulsing the sensor 421 every second. If the reflected signal RS does exceed the predetermined threshold, in step 484 the μC 340 waits to see if the sensor 421 receives a predetermined number (e.g., three) of consecutive reflected signals RS above the predetermined threshold. If not, the μC 340 returns to pulsing the sensor 421 every second. If the μC 340 determines that a predetermined number (e.g., three) of consecutive reflected signals RS above the predetermined threshold has been received, then in step 486 the μC 340 sets the vehicle detected line 356. With a vehicle detected in the corresponding parking space PS, the μC 340 now monitors the parking space PS to see if the vehicle has departed. This is accomplished by again pulsing the sensor 421 every second as shown in step 488 and determining whether a reflected signal below the predetermined threshold has been returned in step 490. If there is no reflected signal RS below the predetermined threshold, then the μC 340 considers the vehicle still present (as shown in step 492) and then continues to pulse the sensor 421 every second as shown in step 488. However, if one reflected signal RS is detected, then it is necessary to first determine if there is any tampering being conducted on the vehicle detecting sensor 421.

It has been found through testing, that where an emitted signal ES from the vehicle sensor 421 does not impact a vehicle, a reflected signal RS is returned below the threshold but with some initial perturbance in the reflected signal RS. This is shown in FIG. 7A. A “no vehicle reflected signal” includes an initial perturbance 45 for a signal that is below the predetermined threshold. However, where a dense object, such as a finger or a hand, is placed against the vehicle detecting sensor 421, the reflected signal RS is 100% “flat-lined” below the predetermined threshold, as shown in FIG. 7B. Thus, the 100% flat-line characteristic of the reflected signal RS is indicative of a tamper condition. As a result, following step 490, it is necessary for the μC 340, in step 494, to determine whether the reflected signal RS has a 100% flat-line characteristic. If it does, then the μC 340 instructs the EPMA 20 to continue to count down any time remaining on the parking meter in step 496 and the μC 340 then returns to step 480 to determine if a vehicle V is in the corresponding parking space PS. If the reflected signal RS below the predetermined threshold does not have a 100% flat-line characteristic, the μC 340 then moves to step 498 where it waits to see if it detects a predetermined number (e.g., three) of consecutive reflected signals RS below the predetermined threshold. If it does, then the μC 340 clears the vehicle detected line 356 in step 500 and then returns to step 480 to look for entry of another vehicle. If the μC 340 does not receive a predetermined number of consecutive reflected signals RS below the predetermined threshold, the μC 340 returns to step 488 to monitor the corresponding parking space PS for vehicle departure.

The vehicle detecting sensor processing electronics 422 are discussed next. It should be noted that Table 1 below contains exemplary part numbers for the various electrical components. It should be understood that these components are listed for example only and that the vehicle detecting sensor processing electronics 422 are not limited, in any manner, to only those components.

FIG. 11A depicts a voltage regulator circuit 360 that converts the +6VDC from the EPMA 20 into +4VDC for use with the vehicle detecting sensor processing electronics 422. Also, a provisional circuit 362 is available for measuring battery voltage or otherwise providing circuitry for supporting a warning indicator as to low battery power.

The voltage detecting sensor 421 has a transducer driver/listen circuit that is activated by the μC 340. A reflected-signal amplification (RSA) circuit 359 (FIGS. 11A-11B), which ultimately transmits the reflected signal to the μC 340 (pin RA0/AN0) for processing, amplifies the reflected signal in preparation for the processing. In particular, the driver/listen circuit 361 is shown in FIG. 11B.

The driver path comprises the transformer T1 which is energized whenever the transistor Q3 is biased on by the μC 340. This energizes the transducer for emitting the 1 msec ultrasonic signal pulse. Once emitted, the transducer then “listens” for the reflection.

The listen path comprises the LM6134 amplifier coupled to the driver circuit. In particular, the listen path is through R14, R21 and C14 into the LM6134. The output of the LM6134 is coupled to the RSA circuit 359. The channel output (see R22 in FIG. 11B) from the listen circuit is coupled to the input (circled letter “A” in FIG. 11A) of the RSA circuit 359. Thus, the reflected signal received by the activated channel is processed by the μC 340, which includes digitizing the received reflected signal. The gain of the RSA circuit 359 can adjusted by the μC 340 as shown the GAIN input in FIG. 11A which is connected to pin RB5 of the μC 340 (FIG. 11C).

As discussed previously, the vehicle detecting sensor processing electronics 422 can be reset automatically whenever the EPMA 20 is reset via the RESET line. In the alternative, if parking authority personnel need to reset the electronics 422 directly, there is a manually-operated switch SW (FIG. 11C) that can momentarily depressed.

It should be understood that the embodiment disclosed herein is exemplary only and that other components having higher resolution could be substituted herewith. However, bearing in mind that minimum power must be used since the parking meter 10 is a stand-alone unit, the above-described embodiment utilizes an 8-bit microcontroller (Microchip's PIC16C73-101/P) for the μC 340.

The sampling rate of the μC 340 is 3 samples/msec. Since sound travels at approximately 1 ft/msec and since only the return trip of the reflected signal is required (i.e., time of flight/2), in order to properly monitor a range of interest (e.g., approximately 0.5 feet to 8 feet) requires 6 samples/ft. Therefore, the activation of the transducer 421 results in 84 samples being temporarily stored in the μC 340 for processing, although only a portion of these (e.g., 48 samples) that fall within the range of interest are analyzed. When the parking meter 10 is first installed, the baseline signal (i.e., the reflected signal corresponding to an empty parking space) for the transducers 421 is obtained and are stored in the memory 342.

When the processor analyzes the received samples, it looks for those samples having the highest values that exceed the predetermined thresholds (which are modifiable by parking meter personnel through a hand-held programming unit, not shown, and the EPMA 20). These thresholds comprise values (e.g., 20 counts) above the baseline signals.

As stated earlier, the RESET line is provided so that the parking authority personnel can reset the vehicle detecting sensor processing electronics 422 at the same time that they set the EPMA 20. In particular, the EPMA 20 may comprise an internal reset switch. Whenever, the parking authority personnel reset the EPMA 20 (e.g., when replacing the batteries in the EPMA 20), the internal reset switch in the EPMA 20 is activated and both the EPMA 20 and the vehicle detecting sensor processing electronics 422 are reset. Other than that, the RESET line is not used during normal operation.

Once the “vehicle detected” line 356 is set, the supporting electronics 21 then awaits payment by coin or payment card. A grace period (e.g., 5-10 minutes; this can be adjusted) is granted by the invention 420 from the time the “vehicle detected” line 356 is set. If the grace period is exhausted before payment is made and the vehicle V remains in the parking space PS, the display 23 and appropriate indicators 50A-50C display a violation. If, on the other hand, payment is received during the grace period, the display 23 displays the amount of purchased time and counts the time down in the conventional manner. If the amount of purchased time is reached and no further payment is made and the vehicle V remains in the parking space PS, the EPMA 20 displays the overtime as a negative value while indicating a violation, thereby leaving no question as to how much overtime has occurred should parking meter personnel issue a citation. If, on the other hand, the vehicle V departs the parking space PS before the purchased amount of time is exhausted, the vehicle detecting sensor 421 will inform the EMPA 20 of the departure by clearing the vehicle detect line 356. The EMPA 20 can be programmed to either zero the display 23 and await the next vehicle V; or alternatively, the EPMA 20 can be programmed to keep the paid-for time on the display 23 while still detecting the entry of a new vehicle and attributing the paid-for time to this new vehicle occupancy of the parking space PS. The decision to zero the display 23 or not is the decision of the municipality or other owner/licensee of the parking meters. In either case, the present invention 420 is capable of easily implementing either decision.

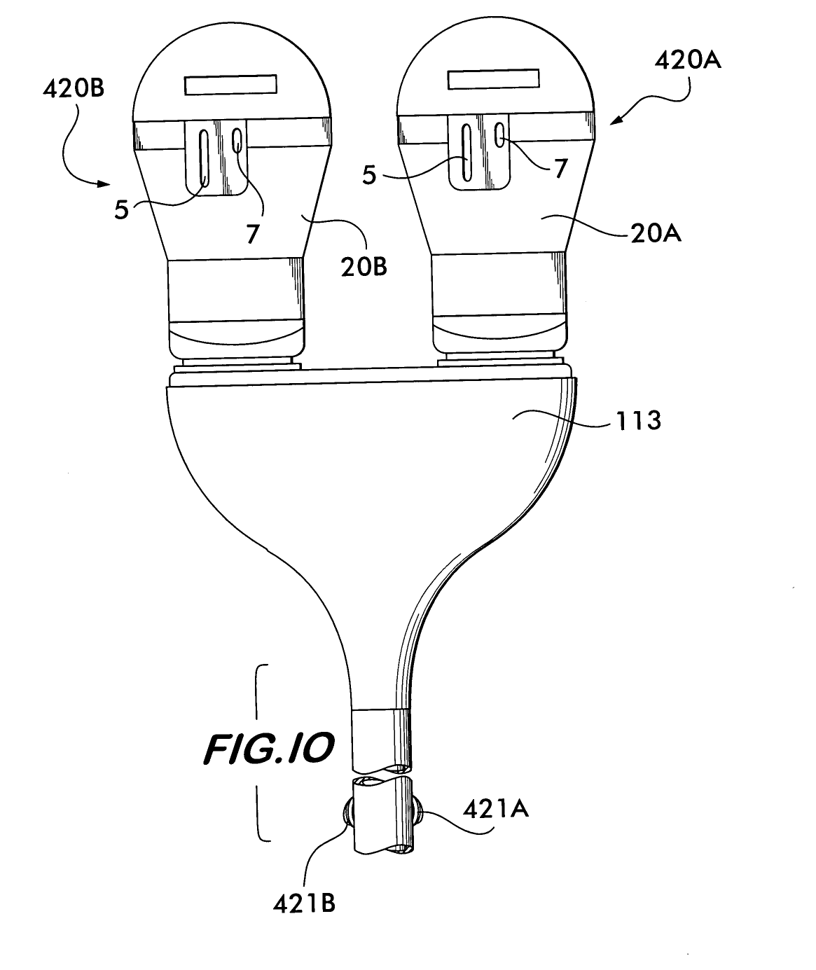

As mentioned earlier, the present invention 420 can be used in a double parking meter configuration as shown in FIGS. 8-10. In particular, municipalities, or privately-owned parking garages or lots may choose to utilize a common vault 113 for two parking meters for adjacent parking spaces. To implement the present invention with such a common vault, a pair of EPMAs 20A and 20B are coupled to the common vault 113 in the conventional manner where a common vault 113 is used. Associated with each EPMA is a respective vehicle detecting sensor 421A and 421B. These sensors 421A and 421B are secured to the stanchion in the same manner described previously with regard to the predetermined height H and the angular orientation a using respective inserts and sleeves as described earlier with regard to the insert 424 and sleeve 430. As shown most clearly in FIG. 9, the respective sensors are oriented towards the corresponding parking space (not shown). Each EPMA/sensor operates independent of the other EPMA/sensor and in accordance with the above discussion. It should be noted that no intermediate housing 416 is used with the EPMAs 20A and 20B and that the respective vehicle detecting sensor electronics 422 can be housed in a portion of the common vault 113 or as part of the supporting electronics 21 of the EPMAs 20A and 20B.

The term “user of the vehicle”, or “associated with the vehicle” or parking space is meant to include anyone who operates the vehicle being parked and/or feeds the corresponding parking meter.

It will be appreciated by those skilled in the art that changes could be made to the embodiments described above without departing from the board inventive concept thereof. It is understood, therefore, that this invention is not limited to the particular embodiments disclosed, but it is intended to cover modifications within the spirit and scope of the present invention.

TABLE 1

| ITEM | DESCRIPTION | MANUFACTURER | PART NO. |
|---|---|---|---|
| C1 | Ceramic Chip Capacitors 0805 5% | Murata GRM40 | 0.1UF 50 V |
| C2 | Tantalum Capacitor | Kemet | 4.7UF 16 V |
| C3 | Ceramic Chip Capacitors 0805 5% | Murata GRM40 | 0.1UF 50 V |
| C4 | Tantalum Capacitor | Kemet | 10UF 6 V |
| C5 | Ceramic Chip Capacitors 0805 5% | Murata GRM40 | 0.1UF 50 V |
| C6 | Ceramic Chip Capacitors 0805 5% | Murata GRM40 | 33 P 50 V |
| C7 | Ceramic Chip Capacitors 0805 5% | Murata GRM40 | 33 P 50 V |
| C9 | Tantalum Capacitor | Kemet | 10UF 6 V |
| C10 | Tantalum Capacitor | Kemet | 4.7UF 16 V |
| C10A | Electrolytic Cap 470UF 10 V | Panasonic | ECE-A1AU471 |
| C11 | Ceramic Chip Capacitors 0805 5% | Murata GRM40 | 0.1UF 50 V |
| C12 | Ceramic Chip Capacitors 0805 5% | Murata GRM40 | 100 P 50 V |
| C13 | Tantalum Capacitor | Kemet | 10UF 6 V |
| C14 | Ceramic Chip Capacitors 0805 5% | Murata GRM40 | 0.01UF 50 V |
| C15 | Ceramic Chip Capacitors 0805 5% | Murata GRM40 | 100 P 50 V |
| C16 | Ceramic Chip Capacitors 0805 5% | Murata GRM40 | 0.01UF 50 V |
| C17 | Ceramic Chip Capacitors 0805 5% | Murata GRM40 | 100 P 50 V |
| C18 | Ceramic Chip Capacitors 0805 5% | Murata GRM40 | 0.01UF 50 V |
| C19 | Ceramic Chip Capacitors 0805 5% | Murata GRM40 | 100 P 50 V |
| C20 | Ceramic Chip Capacitors 0805 5% | Murata GRM40 | 0.01UF 50 V |
| C26 | Ceramic Chip Capacitors 0805 5% | Murata GRM40 | 0.1UF 50 V |
| C27 | Electrolytic Cap 470UF 10 V | Panasonic | ECE- |
| | | | A1AU471 |
| C31 | Ceramic Chip Capacitors 0805 5% | Murata GRM40 | 0.1UF 50 V |
| CN1 | Power Connector for Vehicle | Molex | 22-11-2052 |
| | Detecting Sensor Processing | | |
| | Electronics | | |
| CN2 | Connector for Ultrasonic | Molex | 22-11-2062 |
| | Transducers | | |
| CN3 | Connector for IR Tamper Detect | Molex | 22-11-2042 |
| D2 | Zener Diode SOT23 | Fairchild Or EQ | MMBZ5245B |
| D3 | Zener Diode SOT23 | Fairchild Or EQ | MMBZ5245B |
| D4 | Dual Diode-Small Signal | Fairchild Or EQ | BAV99 |
| D8 | Diode-Small Signal | Fairchild Or EQ | MMBD914LT1 |
| D9 | Zener Diode SOT23 | Fairchild Or EQ | MMBZ5245B |
| D10 | Zener Diode SOT23 | Fairchild Or EQ | MMBZ5245B |
| IC1 | Microcomputer | Microchip | PIC16C73- |
| | | | 10I/P |
| IC2 | EEPROM | Microchip | 24LC04-I/SN |
| IC4 | Quad Op Amp | National Or EQ | LM6134BIM |
| IC5 | Dual Op Amp | Analog Devices | AD8032AR |
| IC6 | Voltage Divider | TI | TLE2426ID |
| IC7 | Dual 4 Line Mux | Fairchild Or EQ | MM74HC4052M |
| IC8 | Quad Op Amp | National Or EQ | LM6134BIM |
| PCB1 | Printed Circuit Board-2 sided | | |
| | 6 × 4 in. | | |
| P1 | Plug for Veh Det Side of Cable | Molex | 22-01-3057 |
| | Pins for Above (5) | Molex | 08-55-0102 |
| P2 | Plug for Meter Side of Cable | Amp | 87631-2 |
| | Pins for Above (5) | Amp | 102128-1 |
| P3 | Plug for Ultrasonic Transducer | Molex | 22-01-3067 |
| | Pins for Above (6) | Molex | 08-55-0102 |
| Cable | 5 Conductor Jacketed Cable - | Alpha Wire Corp | 1175C |
| | 20 inches | | |
| Q3 | Transistor-NPN | Zetex | FMMT491 |
| Q4 | Small Signal Transistor-PNP | Fairchild Or EQ | MMBR4403LT1 |
| Q7 | Small Signal Transistors - NPN | Fairchild Or EQ | MMBR4401LT1 |
| R1 | Resistor 0805 SMD 5% | Dale CRCW-0805 | 4.7K |
| R2 | Resistor 0805 SMD 5% | Dale CRCW-0805 | 4.7K |
| R12 | Resistor 0805 SMD 5% | Dale CRCW-0805 | 10 |
| R13 | Resistor 0805 SMD 5% | Dale CRCW-0805 | 1K |
| R14 | Resistor 0805 SMD 5% | Dale CRCW-0805 | 2K |
| R15 | Resistor 0805 SMD 5% | Dale CRCW-0805 | 10K |
| R16 | Resistor 0805 SMD 5% | Dale CRCW-0805 | 1K |
| R18 | Resistor 0805 SMD 5% | Dale CRCW-0805 | 47K |
| R20 | Resistor 0805 SMD 5% | Dale CRCW-0805 | 10K |
| R21 | Resistor 0805 SMD 5% | Dale CRCW-0805 | 1K |
| R22 | Resistor 0805 SMD 5% | Dale CRCW-0805 | 20K |
| R23 | Resistor 0805 SMD 5% | Dale CRCW-0805 | 1K |
| R24 | Resistor 0805 SMD 5% | Dale CRCW-0805 | 10K |
| R25 | Resistor 0805 SMD 5% | Dale CRCW-0805 | 1K |
| R26 | Resistor 0805 SMD 5% | Dale CRCW-0805 | 20K |
| R27 | Resistor 0805 SMD 5% | Dale CRCW-0805 | 10K |
| R27 | Resistor 0805 SMD 5% | Dale CRCW-0805 | 10K |
| R32 | Resistor 0805 SMD 5% | Dale CRCW-0805 | 10K |
| R40 | Resistor 0805 SMD 5% | Dale CRCW-0805 | 10K |
| R42 | Resistor 0805 SMD 5% | Dale CRCW-0805 | 1K |
| R43 | Resistor 0805 SMD 5% | Dale CRCW-0805 | 8.2K |
| R46 | Resistor 0805 SMD 5% | Dale CRCW-0805 | 2K |
| R47 | Resistor 0805 SMD 5% | Dale CRCW-0805 | 3.9K |
| R48 | Resistor 0805 SMD 5% | Dale CRCW-0805 | 8.2K |
| R52 | Resistor 0805 SMD 5% | Dale CRCW-0805 | 2K |
| R55 | Resistor 0805 SMD 5% | Dale CRCW-0805 | 1K |
| R57 | Resistor 0805 SMD 5% | Dale CRCW-0805 | 20K |
| S1 | Reset Switch | Panasonic | EVQ-PBC09K |
| T1 | Transformer | Datatronics | REF 21817 |
| U1 | Ultrasonic Transducer | APC | APC40T/R- |
| | | | 16E |
| VR1 | Voltage Regulator | Seiko Telcom | S81240PG |
| | | | TC55RP4002E |
| | | | CB713 |
| X1 | 9.8304 MHZ Crystal | Mtron | |
| Z1 | Zero Ohm Jumper 0805 | Dale CRCW-0805 | |
| Z2 | Zero Ohm Jumper 0805 | Dale CRCW-0805 | |

What is claimed is:

1. An electronic parking meter mounted on a support anchored to the ground and adjacent a corresponding parking space, said electronic parking meter comprising:
a stand-alone electronic parking meter housing comprising a display and supporting electronics;
a vehicle detecting sensor located on said support for detecting the presence or absence of a vehicle in a corresponding parking space, said sensor transmitting signals wirelessly towards the parking space and for receiving reflections of said signals if a vehicle is present;
a processor coupled to said vehicle detecting sensor for processing said reflection of said signal, said processor being in communication with said supporting electronics for communicating the presence or absence of a vehicle in the corresponding parking space to said supporting electronics; and
wherein said supporting electronics, processor and vehicle detecting sensor are continuously enabled.

2. The electronic parking meter of claim 1 wherein said vehicle detecting sensor is located at a predetermined position on said support.

3. The electronic parking meter of claim 2 wherein said predetermined position comprises approximately 15 to 25 inches above a ground reference position.

4. The electronic parking meter of claim 3 wherein said predetermined position comprises 21 inches above the ground reference position.

5. The electronic parking meter of claim 1 wherein said vehicle detecting sensor is positioned at an upward angular orientation in the range of 25-35 degrees from a horizontal reference.

6. The electronic parking meter of claim 5 wherein said upward angular orientation is 30 degrees from the horizontal reference.

7. The electronic parking meter of claim 1 wherein said electronic parking meter monitors the time period that a vehicle has occupied the corresponding parking space.

8. The electronic parking meter of claim 1 wherein said electronic parking meter provides a grace period in which to provide payment to said electronic parking meter by a person associated with a vehicle that has just arrived in the corresponding parking space.

9. The electronic parking meter of claim 8 wherein said grace period comprises 5 to 10 minutes after arrival before said electronic parking meter sets a violation condition.

10. The electronic parking meter of claim 1 wherein said electronic parking meter continues to monitor the presence of a vehicle in the corresponding parking space even when an amount of time purchased by a person associated with the vehicle has been exceeded.

11. The electronic parking meter of claim 1 wherein said display displays the amount of time purchased by a user of the corresponding parking space and wherein said electronic parking meter can reset to zero any amount of time left on said electronic parking meter even though the vehicle has departed the corresponding parking space.

12. The electronic parking meter of claim 1 wherein said vehicle detecting sensor comprises an ultrasonic transducer.

13. The electronic parking meter of claim 1 wherein said processor pulses said vehicle detecting sensor once every second to emit wireless signals.

14. The electronic parking meter of claim 1 wherein said processor determines if said received reflections comprise amplitudes above a predetermined threshold.

15. The electronic parking meter of claim 14 wherein said processor monitors said received reflections and communicates a vehicle detected signal to said supporting electronics if a predetermined number of consecutive reflections having amplitudes above said predetermined threshold occurs.

16. The electronic parking meter of claim 15 wherein said predetermined number is three.

17. The electronic parking meter of claim 15 wherein said processor determines whether a second predetermined number of consecutive reflections have amplitudes below said predetermined threshold and wherein each of said reflections below said predetermined threshold have a 100% flat-line characteristic.

18. The electronic parking meter of claim 17 wherein said second predetermined number of consecutive reflections is three.

19. The electronic parking meter of claim 17 wherein said processor communicates a no vehicle condition to said supporting electronics if said predetermined number of consecutive reflections have amplitudes below said predetermined threshold and none of said consecutive reflections have a 100% flat-line characteristic.

20. The electronic parking meter of claim 17 wherein said processor communicates a vehicle detected condition to said supporting electronics if one of said received reflections has a 100% flat-line characteristic and has an amplitude below said predetermined threshold.

21. The electronic parking meter of claim 1 wherein said vehicle detecting sensor communicates wirelessly with said supporting electronics.

22. A method for automatically leasing, and displaying violations of, the use of a parking space, said method comprising the steps of:
positioning a stand-alone electronic parking meter having a display and supporting electronics including coin or payment card processors on a support anchored to the ground and adjacent the parking space;
positioning a vehicle detecting sensor on said support at a predetermined height above the ground, said vehicle detecting sensor and said supporting electronics being in communication with each other;
orienting said vehicle detecting sensor for emitting wireless signals towards the parking space at a predetermined angle with respect to a horizontal reference, said vehicle detecting sensor also receiving any reflections of said emitted wireless signals;
processing said received reflections to determine the presence or absence of a vehicle in the parking space and informing said supporting electronics of the presence or absence of a vehicle in the parking space; and
continuously enabling said electronic parking meter and vehicle detecting sensor.

23. The method of claim 22 wherein said predetermined height comprises approximately 15 to 25 inches above the ground.

24. The method of claim 23 wherein said predetermined position comprises 21 inches above the ground reference position.

25. The method of claim 22 wherein said vehicle detecting sensor is positioned at an upward angular orientation in the range of 25-35 degrees from a horizontal reference.

26. The method of claim 25 wherein said upward angular orientation is 30 degrees from the horizontal reference.

27. The method of claim 22 wherein said electronic parking meter monitors the time period that a vehicle has occupied the corresponding parking space.

28. The method of claim 27 wherein said electronic parking meter provides a grace period in which to allow payment to be made to said electronic parking meter by a person associated with a vehicle that has just arrived in the corresponding parking space before displaying a violation on said display.

29. The method of claim 28 wherein said grace period comprises 5 to 10 minutes after arrival of the vehicle in the parking space.

30. The method of claim 27 wherein said electronic parking meter continues to monitor the presence of a vehicle in the corresponding parking space even when an amount of time purchased by a person associated with the vehicle has been exceeded.

31. The method of claim 22 wherein said display displays the amount of time purchased by a user of the corresponding parking space and wherein said electronic parking meter can reset to zero any amount of time left on said electronic parking meter even though the vehicle has departed the corresponding parking space.

32. The method of claim 22 wherein said step of emitting wireless signals comprises pulsing said vehicle detecting sensor once a second.

33. The method of claim 22 wherein said step of processing said received reflections comprises determining if an amplitude of each of said received reflections is above a predetermined threshold.

34. The method of claim 33 wherein said step of processing said received reflections comprises determining that a vehicle is present if a predetermined number of consecutive received reflections comprise amplitudes above said predetermined threshold.

35. The method of claim 34 wherein said predetermined number of consecutive received reflections is three.

36. The method of claim 34 wherein said step of processing said received reflections comprises determining if an amplitude of each of said reflections is below said predetermined threshold.

37. The method of claim 36 wherein said step of processing said received reflections further comprises determining whether each received reflection has a 100% flat-line characteristic.

38. The method of claim 37 wherein said step of processing said received reflections comprises determining that a vehicle is not present if a second predetermined number of consecutive received reflections comprise amplitudes below said predetermined threshold and none of said received reflections has a 100% flat-line characteristic.

39. The method of claim 38 wherein said second predetermined number of consecutive reflections comprises three.

40. The method of claim 37 wherein said step of processing said received reflections comprises determining that a vehicle is present in the parking space if one of said received reflections has a 100% flat-line characteristic and is has an amplitude below said predetermined threshold.

41. The method of claim 22 wherein said vehicle detecting sensor is an ultrasonic sensor.

42. The method of claim 22 wherein said vehicle detecting sensor communicates wirelessly with said electronic parking meter.
